(19) United States
(12) Patent Application Publication
(10) Pub. No.: US 2007/0182182 A1
(43) Pub. Date: Aug. 9, 2007

(54) Motor Vehicle for a Drywall Business

(76) Inventor: David R. Hall, Provo, UT (US)

Correspondence Address: TYSON J. WILDE;NOVATEK INTERNATIONAL, INC., 2185 SOUTH LARSEN PARKWAY, PROVO, UT, 84606, US

(21) Appl. No.: 11/307,407

(22) Filed: Feb. 6, 2006

Related U.S. Application Data
(63) Continuation-in-part of application No. 11/306,302.

(51) Int. Cl. B60P 3/14

(52) U.S. Cl. 296/24.32

(57) ABSTRACT

A motor vehicle for a drywall business having a first enclosure comprising a walkway, at least one drywall equipment storage device adjacent the walkway and secured within the first enclosure; a work station for servicing drywall equipment adjacent the walkway and secured within the first enclosure; a second enclosure comprising a power washer system adapted for cleaning drywall equipment; an inventory management system for tracking the drywall equipment; and an accounting system adapted to perform activities related to payment for providing the drywall equipment.

### RELATED APPLICATIONS

This application relates to U.S. patent application Ser. No. 11/306,302 filed on Dec. 22, 2005 entitled “A Method for Conducting a Drywall Business,” which is herein incorporated by reference for all that it contains.

### BACKGROUND OF THE INVENTION

In the drywall industry, the ability to provide superior service at the lowest possible cost may be imperative. Unproductive time dealing with drywall equipment maintenance and/or returning the equipment to a renter may frustrate consumers. Presently, drywall sheets may be delivered to a jobsite by a party other than those who are hanging and finishing the drywall sheets, but the equipment needed to hang and finish the drywall sheets may not be delivered to the consumer. Consumers may own the equipment themselves or rent it from a store. When consumers rent from a store, the store usually offers services such as replacement and maintenance which may be performed at the store. This may require consumers to pay one or more persons to take the used equipment to the store, get it serviced or get new equipment, and return to the jobsite. The result may be a higher cost for the contractor.

In the prior art, there are motor vehicles used in the drywall industry to deliver drywall sheets. One such motor vehicle is disclosed by Robert's Diesel Works Inc. Robert's Diesel Works Inc. makes large boom trucks designed to transport drywall sheets to the jobsite and lift them into the building under construction.

### BRIEF SUMMARY OF THE INVENTION

In one aspect of the invention, a motor vehicle may be equipped to store and provide drywall equipment to consumers. The motor vehicle comprises an automobile, an automobile with a trailer, an automobile with a semi trailer, a truck, a truck with a trailer, a truck with a semi-trailer, an airplane, a train, a boat, or combinations thereof. The motor vehicle comprises a first enclosure comprising a walkway, at least one equipment storage device adjacent the walkway and secured within the first enclosure, and a work station for servicing drywall equipment adjacent the walkway and secured within the first enclosure. The motor vehicle also comprises a second enclosure comprising a power washer system adapted for cleaning drywall equipment. Additionally, the motor vehicle comprises an inventory management system for tracking the drywall equipment and an accounting system adapted to perform activities related to payment for providing the drywall equipment.

A motor vehicle so equipped may allow a company to take the equipment necessary for working with drywall to the jobsite, replace the equipment at the jobsite, and perform maintenance on the equipment at the jobsite. Such a motor vehicle may be capable of saving the consumer time and money.

### BRIEF DESCRIPTION OF THE DRAWINGS

The foregoing and other features of the present invention will become more fully apparent from the following description, taken in conjunction with the accompanying drawings. Understanding that these drawings depict only typical embodiments in accordance with the invention and are, therefore, not to be considered limiting of its scope, the invention will be described with additional specificity and detail through use of the accompanying drawings in which:

FIG. 1 is a perspective diagram of an embodiment of a motor vehicle showing a generator in a storage compartment in the motor vehicle.

FIG. 2 is a perspective diagram of another embodiment of a motor vehicle showing a generator secured outside the motor vehicle.

FIG. 3 is a perspective diagram of an embodiment of a first enclosure.

FIG. 4 is a perspective diagram of an embodiment of a second enclosure.

FIG. 5 is a perspective diagram of another embodiment of a second enclosure.

FIG. 6 is a perspective diagram of an embodiment of inventory management and accounting systems.

FIG. 7 is a perspective diagram of an embodiment of wireless inventory management and accounting systems.

FIG. 8 is a perspective diagram of the interior of a motor vehicle.

FIG. 9 is a perspective diagram of an embodiment of a tool that may be stocked in a motor vehicle.

### DETAILED DESCRIPTION OF THE INVENTION AND THE PREFERRED EMBODIMENT

It will be readily understood that the components of the present invention, as generally described and illustrated in the Figures herein, may be arranged and designed in a wide variety of different configurations. Thus, the following, more detailed description of embodiments of the apparatus of the present invention, as represented in the Figures is not intended to limit the scope of the invention, as claimed, but is merely representative of various selected embodiments of the invention.

The illustrated embodiments of the invention will best be understood by reference to the drawings, wherein like parts are designated by like numerals throughout. Those of ordinary skill in the art will, of course, appreciate that various modifications to the apparatus described herein may easily be made without departing from the essential characteristics of the invention, as described in connection with the Figures. Thus, the following description of the Figures is intended only by way of example, and simply illustrates certain selected embodiments consistent with the invention as claimed herein.

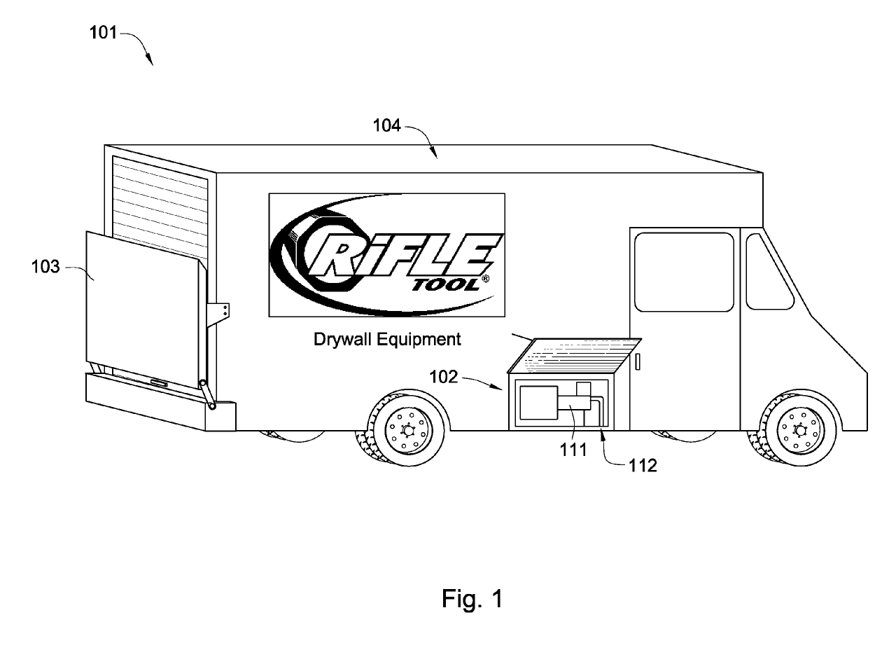

FIG. 1 is a perspective diagram of an embodiment of a motor vehicle 101 having a generator 111 in a storage compartment 102 in the motor vehicle 101. The storage compartment 102 may be accessible from inside the motor vehicle 101, outside the motor vehicle 101, or both. The generator 111, may be connected to an electrical system located on the motor vehicle 101 and may be equipped with a pipe 112, hose, tube, or other similar object to enable the venting of exhaust from the generator to outside the motor vehicle 101. If the storage compartment 102 is accessible only from the outside and does not have any opening to inside the motor vehicle 101, the pipe 112 may not be required. If, however, the storage compartment does have openings to the exterior and interior of the motor vehicle 101, a pipe 112 may be beneficial to ensure exhaust is vented outside the motor vehicle 101 rather than inside.

An adjustable platform 103 is held in a vertical position and is secured to the rear of the motor vehicle. The platform 103 may be used as a work station or be used to lift heavy objects. As shown in FIG. 1, the platform 103 blocks the gate leading within the first enclosure 104.

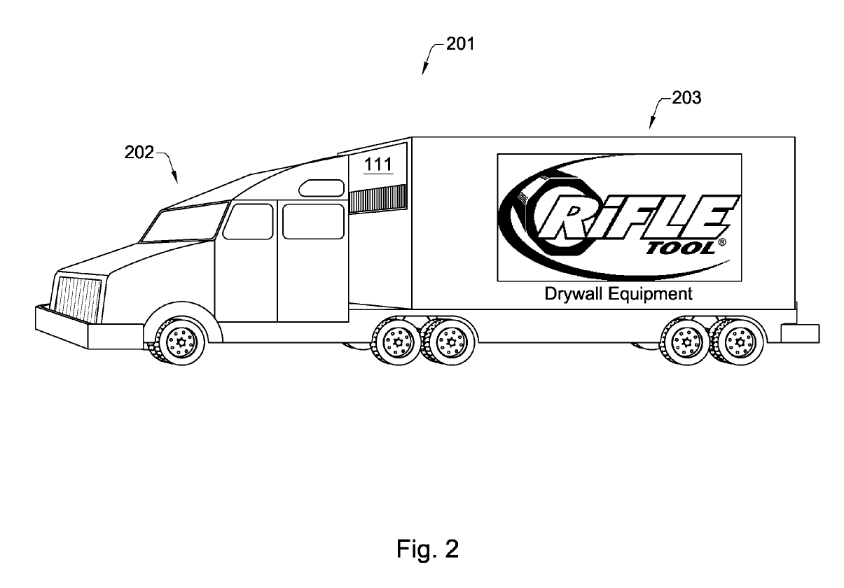

FIG. 2 is a perspective diagram of another embodiment of a motor vehicle 101 showing a generator 111 outside the motor vehicle 101 and secured to the motor vehicle 101. The motor vehicle 101 may be a tractor-trailer 201 comprising at least a tractor 202 and a semi-trailer 203. A tractor-trailer 201 may be useful for large projects such as building or repairing commercial or residential buildings or developments.

In this embodiment, the semi-trailer 203 is the first enclosure. The generator 111 may be secured to the outside of the semi-trailer 203 to eliminate the need for directing the venting of exhaust from the generator 111, and to minimize the noise made by the generator.

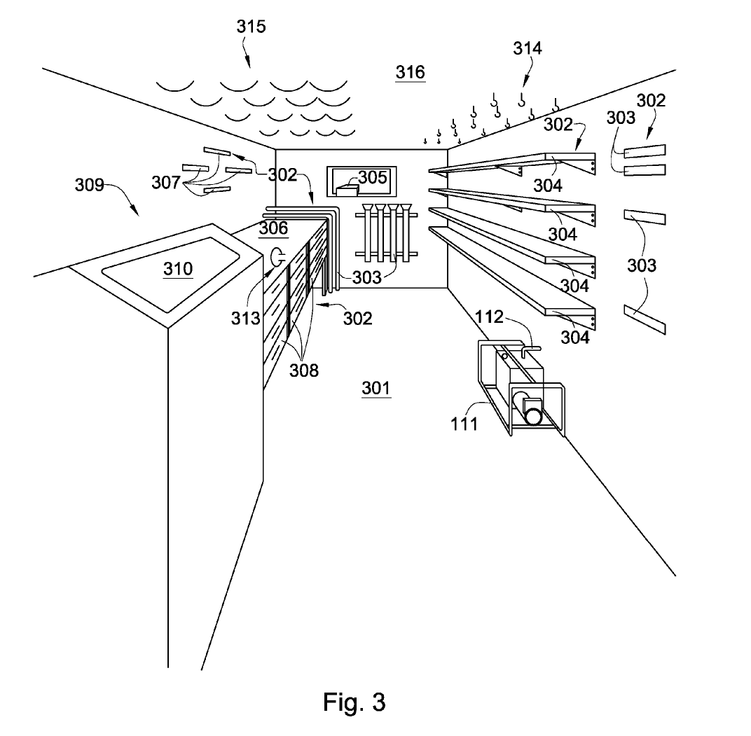

FIG. 3 is a perspective diagram of an embodiment of a first enclosure 104 including a second enclosure 310 within the first enclosure 104. The first enclosure 104 may comprise a walkway 301 in the middle of the first enclosure 104. The walkway 301 may be partitioned using a door, wall, or other similar object. Drywall equipment storage devices 302 may be adjacent both sides of the walkway and may include racks 303, shelves 304, a container 305, a table 306, magnetic strips 307, and drawers 308. Racks 303 may be useful in holding larger equipment such as automatic tapers and extension handles. Shelves 304 may be useful for storing flat boxes, hawks, and knives. Containers 305 and drawers 308 may be used to hold smaller items such as drywall screws. A table 306 may be used to store drywall equipment as well provided that it may be secured while the motor vehicle is in motion. The table 306 may be large enough to accommodate drywall equipment. Magnetic strips 307 are also useful for smaller tools made of metal. Hammers, screwdrivers, and pliers are just some of the tools that may be stored using the magnetic strips 307.

The first enclosure may also comprise a work station 309 for servicing drywall equipment. The work station may include the table 306 and/or the second enclosure 310. The work station may be adjacent the walkway 301 and secured within the first enclosure 104. The table 306 may be equipped with a clamp 313 that may be used to secure drywall equipment during servicing. The second enclosure 310 may be secured within the first enclosure 104, but may also be secured to another portion of the motor vehicle.

The second enclosure 310 may comprise a power washer system. Drywall equipment may be placed within the washer such that the drywall equipment is subjected to the cleaning material. The source of the cleaning material may be secured within the motor vehicle 101, second enclosure 310, or to the outside the motor vehicle 101.

In other embodiments, the motor vehicle may comprise a high pressure hose for cleaning the drywall equipment in the second enclosure 310. The hose may be secured inside or outside the motor vehicle. The second enclosure 310 may also comprise a means of manual cleaning e.g. a basin secured in the second enclosure 310 so that drywall equipment may be washed by hand.

Services pertaining to the drywall equipment may vary. Replacing equipment may be an important service when equipment becomes damaged or dirty. Onsite cleaning and/or repair may save a consumer time and money, especially if the damaged or dirty equipment is readily replaceable, allowing the consumer to continue working. Replenishing materials, such as joint compound and joint tape, may also be an important service provided by the party operating the motor vehicle. On-hand materials in the motor vehicle may allow replenishing to be done quickly. Upgrades may also be performed. If new drywall equipment is released, older equipment may be circulated out and replaced with the newer equipment.

The first enclosure 104 may also comprise a generator 111 which may be connected to an electrical system located on the motor vehicle. The generator may be equipped with a pipe 112, hose, tube, or other similar object to enable the venting of exhaust from the generator 111 to outside the motor vehicle.

The first enclosure 104 may also comprise devices adapted to secure drywall equipment to the ceiling 316 such devices as hooks 314 and elastic bands 315. Drywall equipment may be hung from the hooks 314 with rope or bungee cords. The elastic bands 315 may secure the drywall equipment to the ceiling in a manner which would allow the motor vehicle to be in motion without the drywall equipment falling or shifting in an unacceptable manner.

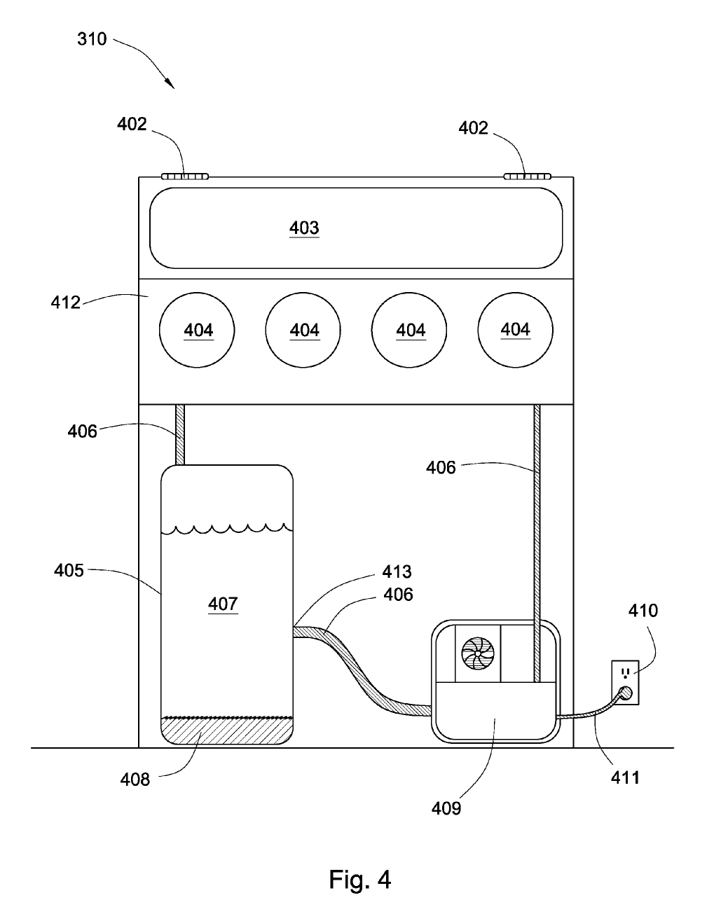

FIG. 4 is a perspective diagram of an embodiment of the second enclosure 310 which contains a recirculating power washer system. The power washer system may be recirculating or non-recirculating. A recirculating washer is a washer which circulates a cleaning material between a reservoir 405 and a washing area. The cleaning material 407 may be a fluid, grit, or combinations thereof. Drywall equipment may be placed within the washer such that the drywall equipment is subjected to the cleaning material. The second enclosure 310 may be completely enclosed, although in certain embodiments there may be an opening allowing the operators access to the interior of the enclosure 310. The interior may be accessed by lifting a lid 401 attached to the second enclosure 310 with hinges 402. The lid 401 may comprise a window 403 which allows the operator to view the equipment within the second enclosure 310. A sidewall 412 of the second enclosure 310 may be equipped with gloves 404 which may allow the operator to manipulate the equipment inside the second enclosure 310 without exposing him or herself to the cleaning material 407.

Still referring to FIG. 4, the second enclosure 310 has a drain that is connected to a reservoir 405, the reservoir being the source of the cleaning material 407 in a recirculating washer, via a pipe, hose 406, tube, or other similar object allowing circulation of the cleaning material 407. The reservoir 405 is constructed to allow particulate matter 408 washed off the drywall equipment to settle on the bottom of the reservoir 405. The connection 413 between the hose 406 and the reservoir 405 is high enough that particulate matter 408 will not be pumped back into the second enclosure 310. A filter may also be used to keep the recirculating system clean.

The power washer may also be connected to an electrical system located on the motor vehicle 101 or the generator 111 through an electrical output device 410 via an electrical cord 411. The generator 111 may also be powered by an internal combustion engine.

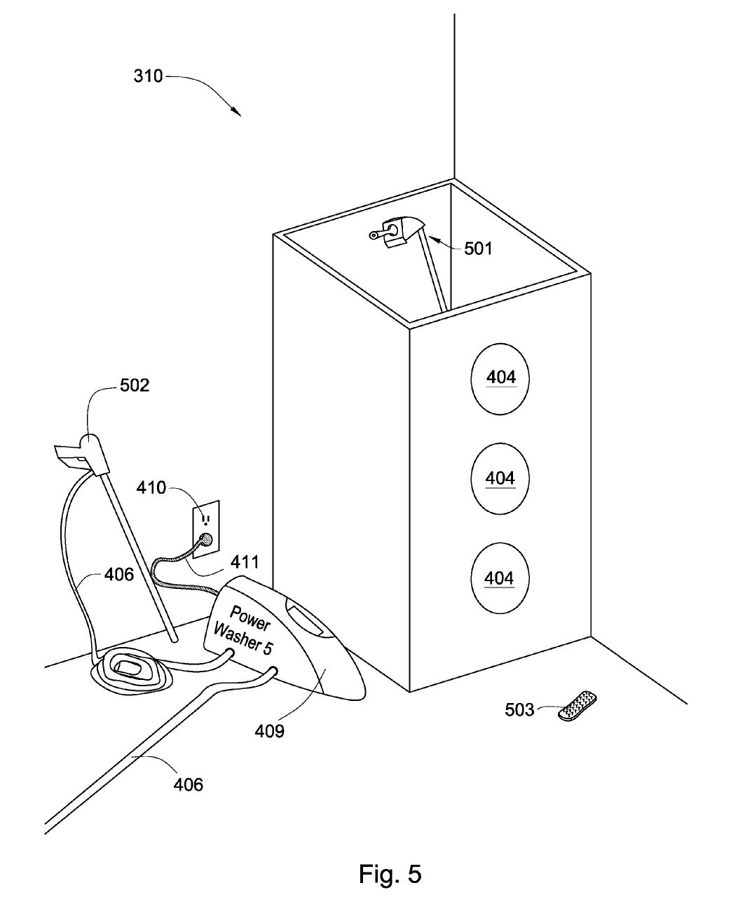

FIG. 5 is a perspective diagram of another embodiment of the second enclosure 310. The second enclosure 310 may be open at the top allowing the placement of drywall equipment 501 into the enclosure 310. In FIG. 5, the power washer 409 is non-recirculating. The source of the cleaning material 407 may be from outside the motor vehicle, such as a spigot at a house or business, which is brought to the power washer 409 by a hose 406. The power washer 409 may also have a self-contained reservoir, which is also considered a source of cleaning material 407. The operator of the power washer 409 may use a wand 502 to direct pressurized cleaning material 407 at drywall equipment 501 within the second enclosure 310. A hose 406 may connect the wand 502 to the power washer 409. Cleaning material 407 may be collected in the second enclosure 310 and is disposed of later, either during cleaning or following cleaning. Cleaning material 407 may also drain out of the second enclosure 310. The power washer 409 may be connected to the motor vehicle's electrical system or generator 111 through an electrical output device 410 via an electrical cord 411.

The second enclosure 310 may also include gloves 404 to allow the operator to use an object, such as a brush 503, to clean the drywall equipment 501. This type of second enclosure 310 may also be used outside of the motor vehicle 101. The second enclosure 310 may be constructed of a light weight material that enables it to be easily moved. One may move the second enclosure 310 to the platform 103 on the back of the motor vehicle 101, or the second enclosure 310 may be collapsible and attached to the outside of the motor vehicle 101 and expanded when needed.

It should also be said that the power washer 409 may be automated. The operator may simply place the dirty equipment in the second enclosure 310 and turn on the automatic power washer which may operate similar to an automatic car wash, but on a smaller scale.

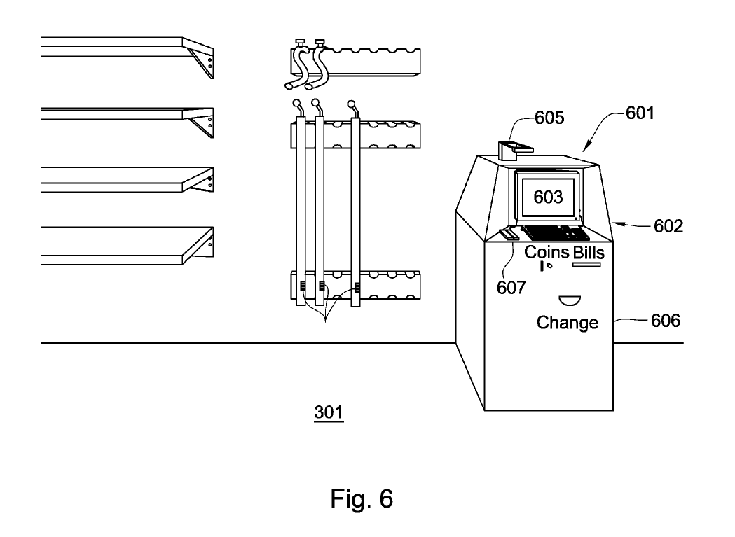

FIG. 6 is a perspective diagram of an embodiment of an inventory management system 601 and an accounting system 602. The inventory management system 601 and the accounting system 602 may be located in the first enclosure 104, a cabin of the motor vehicle 101, a storage compartment in the motor vehicle 102, or combinations thereof. In the first enclosure 104, the inventory management system 601 and accounting system 602, may be adjacent the walkway 301 and secured in the first enclosure 014.

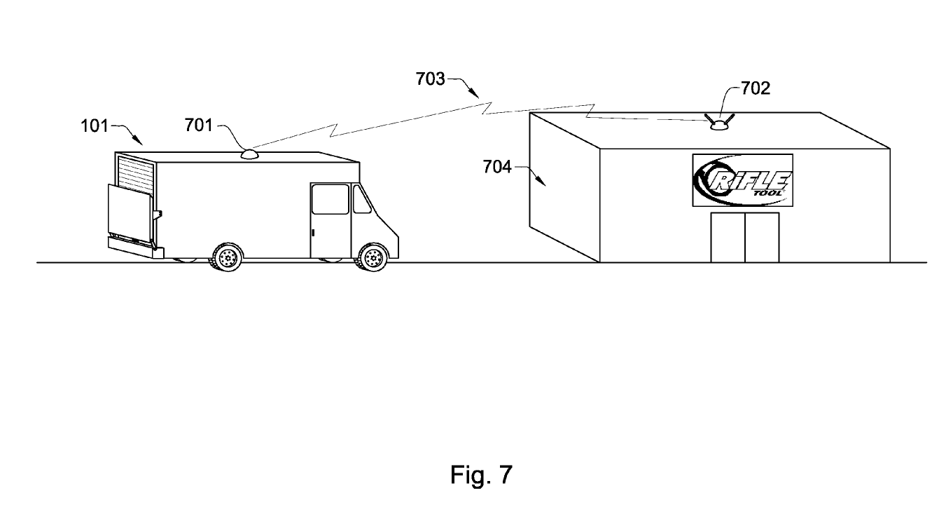

The inventory management system 601 may be manual (paper and writing implement), mechanical (mechanical cash register), electronic (computer 603, RFID, video verification), optical (barcode 604 and barcode scanner 605), or combinations thereof. Each type of system may have various components. For instance, an electronic inventory management system 601 may include the components listed above, and additionally, the optical components. The accounting system 602 may be manual (ledger), mechanical (mechanical cash register), electronic (computer 603, apparatus for swiping a credit card 607), or combinations thereof. The accounting system may also have various components in it. Additionally, the accounting system 602 may have a cash machine 606 to enable a second party to pay with cash while providing security for the money. The cash machine 606 may be connected to the computer 603. A cash box may also be used for the handling of cash transactions. The accounting system 602 may also have a secure box or safe for checks to enable the second party to pay with a check. The accounting system 602 for charging may include a credit/debit card reader 607. When a credit card is swiped, the computer 603 records the card's information. The inventory management system 601 may include providing the drywall equipment with a magnetic strips or bar codes which may be recorded by a scanner 605. Further, the computer 603 and wireless system, described hereafter in FIG. 7, may enable the first party to accept electronic checks.

The inventory management system 601 may be adapted to perform an action selected from the group consisting of tracking the amount of items in stock, tracking the time until equipment needs calibration, tracking where the equipment is, tracking maintenance performed on the equipment, tracking what equipment is needed, or combinations thereof. The accounting system 602 may be adapted to perform activities related to payment selected from the group consisting of creating an invoice, initiating payment, processing payment, completing payment, confirming payment, creating a receipt, or combinations thereof.

FIG. 7 is a perspective diagram of an embodiment of a wireless inventory management and/or accounting system. It further demonstrates the utility of the inventory management system 601 and the accounting system 602. The system for tracking inventory and the system related to payment may be connected to a remote location 704 via a wireless connection. The wireless signal 703 may be sent from the motor vehicle 101 via a first wireless transceiver 701 using protocols such as WiFi, Bluetooth; means such as radio, cellular, infrared; apparatuses such as satellite dishes, cards for computers or Personal Digital Assistants (PDAs) that connect through cell phone service providers or hot spots; or combinations thereof. The wireless signal 703 may be received by a second wireless transceiver 702, at a remote location 704 and may be connected to a remote server. It may enable real-time updates to customer accounts rather than waiting for the updates to be done at specific intervals.

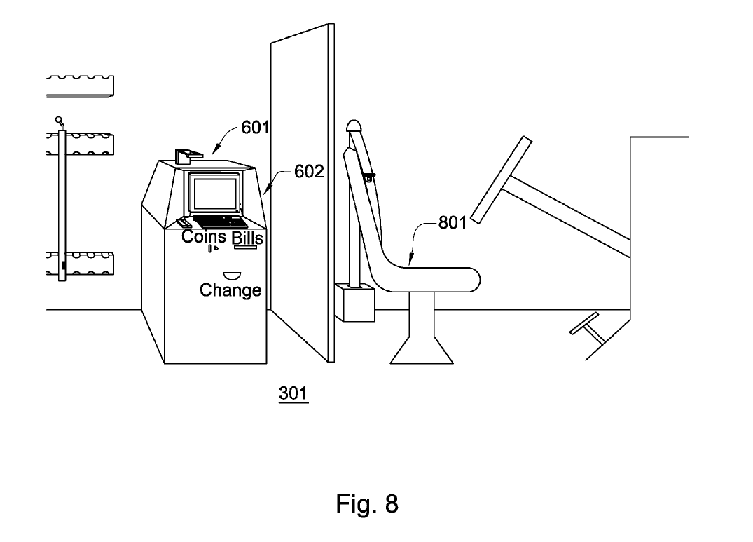

FIG. 8 is a perspective diagram of the interior of a motor vehicle 101. Pictured are the walkway 301, the inventory management system 601, and the accounting system 602. Additionally, the driver's seat 801 is also pictured. The driver's seat 801 may be adjacent the walkway 301.

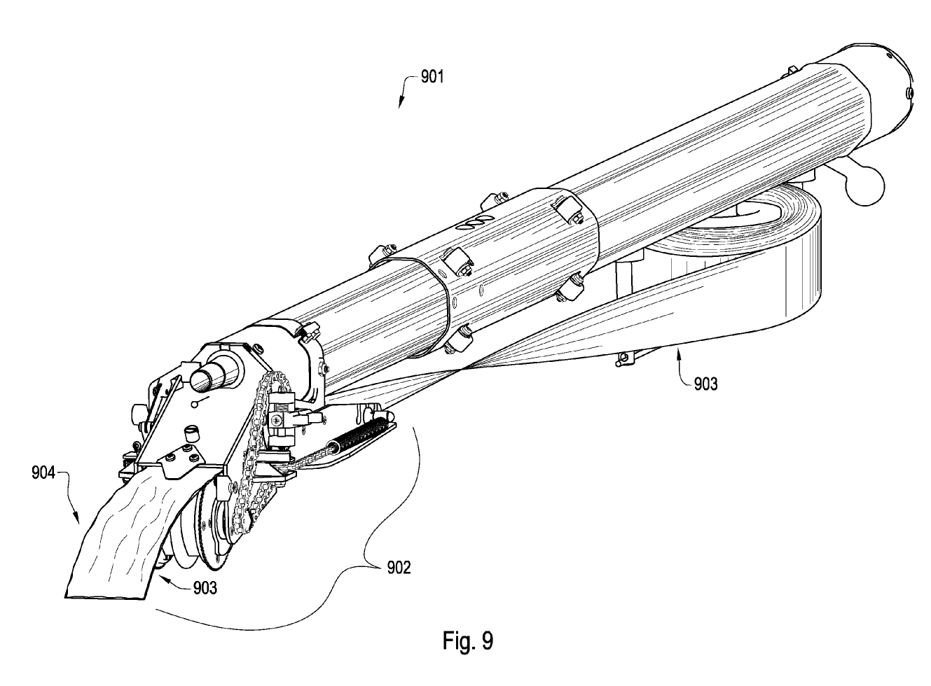

FIG. 9 is a perspective diagram of an embodiment of a tool that may be stocked in the motor vehicle 101. Such a tool 901 may be known as an automatic taper. The automatic taper 901 may be filled with joint compound 904 and may have joint tape 903 attached to it. The tape is fed through the automatic taper's head 902. At the head 902, the joint tape 903 is coated with joint compound 904 prior to application. The automatic taper 901 may replace the need for drywall tools such as hawks, trowels, knives, etc. An automatic taper 901 shown in FIG. 9 may be repaired if joint compound 904 is jammed in the taper 901 or if a wheel breaks. Repairing broken drywall equipment in the motor vehicle 201 may save time, especially if the motor vehicle 201 is onsite. Cleaning drywall equipment is also very important. If joint compound 904 hardens, it may ruin drywall equipment. The automatic taper 901, for example, contains joint compound 904 and distributes it through the head 902. Because of this, the head 902 may become covered in joint compound 904, and, if allowed to dry, may damage the taper 901. Additionally, if joint compound 904 is allowed to dry inside the automatic taper 901, the distribution of drywall equipment 501 may be affected.

What is claimed is:

1. A motor vehicle for a drywall business, comprising:
a first enclosure comprising:
a walkway;
at least one drywall equipment storage device adjacent the walkway and secured within the first enclosure;
a work station for performing services pertaining to drywall equipment adjacent the walkway and secured within the first enclosure;
a second enclosure comprising a power washer system adapted for cleaning drywall equipment;
an inventory management system for tracking the drywall equipment; and
an accounting system adapted to perform activities related to payment for providing the drywall equipment.

2. The motor vehicle of claim 1, wherein the motor vehicle comprises an automobile, an automobile with a trailer, an automobile with a semi trailer, a truck, a truck with a trailer, a truck with a semi-trailer, an airplane, a train, a boat, or combinations thereof.

3. The motor vehicle of claim 1, wherein the drywall equipment storage device comprises a rack, shelf, container, table, magnetic strip, drawer, or combinations thereof which are adequate for the storage of drywall equipment.

4. The motor vehicle of claim 1, wherein the work station is adapted for repairing drywall equipment, cleaning drywall equipment, replacing drywall equipment, replenishing materials used with drywall equipment, upgrading drywall equipment, or combinations thereof.

5. The motor vehicle of claim 1, wherein the motor vehicle comprises an electric generator.

6. The motor vehicle of claim 5, wherein the electric generator is located in the first enclosure, a storage compartment in the motor vehicle, outside the motor vehicle and secured to the motor vehicle, or combinations thereof.

7. The motor vehicle of claim 1, wherein the work station comprises a table large enough to accommodate drywall equipment.

8. The motor vehicle of claim 7, wherein the work station comprises at least one clamp to secure drywall equipment while performing maintenance.

9. The motor vehicle of claim 1, wherein the power washer comprises a recirculating washer.

10. The motor vehicle of claim 9, wherein the recirculating washer is connected to an electrical system located on the motor vehicle.

11. The motor vehicle of claim 10, wherein the electrical system comprises the vehicle's electrical system, the electric generator, or combinations thereof.

12. The motor vehicle of claim 1, wherein the inventory management system is manual, electronic, or combinations thereof.

13. The motor vehicle of claim 12, wherein the inventory management system is located in the first enclosure, a cabin, a storage compartment in the motor vehicle, or combinations thereof.

14. The motor vehicle of claim 12, wherein the inventory management system is connected to a remote location via a wireless connection.

15. The motor vehicle of claim 1, wherein the accounting system performs activities related to payment comprising the functions of creating an invoice, initiating payment, processing payment, completing payment, confirming payment, creating a receipt, or combinations thereof.

16. The motor vehicle of claim 15, wherein the accounting system is located in the first enclosure, a cabin, a storage compartment in the motor vehicle, or combinations thereof.

17. The motor vehicle of claim 15, wherein the accounting system is manual, mechanical, electronic, or combinations thereof.

18. The motor vehicle of claim 15, wherein the accounting system is connected to a remote location via a wireless connection.

19. The motor vehicle of claim 1, wherein the driver's seat is located adjacent the walkway.

20. The motor vehicle of claim 1, wherein the ceiling of the first enclosure comprises devices such as hooks or elastic bands adapted to secure drywall equipment to the ceiling.
